(19) United States
(12) Patent Application Publication
(10) Pub. No.: US 2025/0292216 A1
(43) Pub. Date: Sep. 18, 2025

(54) APPARATUS, SYSTEM AND METHOD FOR GARBAGE HANDLING

(71) Applicant: Stanislav Kulyk, Lublin (PL)

(72) Inventor: Stanislav Kulyk, Lublin (PL)

(21) Appl. No.: 18/607,840

(22) Filed: Mar. 18, 2024

Related U.S. Application Data
(60) Provisional application No. 63/521,965, filed on Jun. 20, 2023.

(51) Int. Cl. G06Q 10/30; G05B 15/02

(52) U.S. Cl. CPC G06Q 10/30; G05B 15/02

(57) ABSTRACT

The present disclosure discloses an apparatus, a system, and a method for garbage handling. The garbage handling apparatus includes a container vault to store one or more containers, a dispensing section to dispense at least one container from the one or more containers, a receiver section to receive a used waste container; and a computer. The computer is configured to trigger a dispensing mechanism to move the at least one container from the container vault to the dispensing section based on a request for dispensing, and trigger a sorting mechanism to dispose the used waste container based on a request for collection of the used waste container, wherein the request for collection indicates a type of waste and the sorting mechanism is performed based on the type of waste.

### CROSS-REFERENCE TO RELATED APPLICATIONS

The present application claims the benefit of a provisional patent application under 35 U.S.C. § 119 (e) having Ser. No. 63/521,965 filed on Jun. 20, 2023, by Stanislav Kulyk. Embodiments of the provisional patent application are incorporated herein by reference, including the specification.

### TECHNICAL FIELD

The present disclosure relates to the field of waste management. More specifically, the present disclosure relates to apparatus, system, and method for garbage handling.

### BACKGROUND

Many developed states have implemented garbage pre-sorting procedures to address the significant amount of waste generated due to high consumer demand. This involves placing designated dumpsters within residential complexes for specific types of waste such as metal, glass, paper, plastic, and food. Typically, residents are obligated to dispose of their segregated garbage, thereby helping to facilitate recycling and reuse efforts.

The primary issue with this approach is the lack of discipline in following waste segregating rules among many citizens, leading to increased fines and fees imposed by garbage collectors on the entire residential complexes. This contradicts the principle of individualism since even those who segregate waste diligently are penalized. Moreover, charging the same garbage removal fee for each resident goes against the principle of individualism. It would be more appropriate for those generating more waste to pay a higher fee than those producing less.

Further, the accessibility of a dumpsters makes them susceptible to theft of pre-sorted metal, resulting in financial losses for waste processing facilities. Further, visually impaired individuals cannot interact with dumpsters, highlighting the need for a new approach to garbage disposal that accommodates tactile and sound perceptions. Therefore, there is a requirement for an optimized waste management system that encourages proper waste disposal.

### SUMMARY

An apparatus, a system and a method for garbage handling are provided herein that focuses on the optimization and design of waste management system to encourage proper waste disposal.

In an aspect, a garbage handling apparatus is provided. The garbage handling apparatus includes a container vault to store one or more containers, a dispensing section to dispense at least one container from the one or more containers, a receiver section to receive a used waste container; and a computer. The computer is configured to trigger a dispensing mechanism to move the at least one container from the container vault to the dispensing section based on a request for dispensing and trigger a sorting mechanism to dispose the used waste container based on a request for collection of the used waste container, wherein the request for collection indicates a type of waste and the sorting mechanism is performed based on the type of waste.

In an embodiment, each of the one or more containers and the used waste container is associated with an identification tag.

In an embodiment, the garbage handling apparatus further includes an identification tag reader arranged within the receiving section to scan an identification tag of the used waste container and send information relating to the scanned identification tag to the computer.

In an embodiment, the computer may be configured to receive the request for collection of the used waste container, wherein the request for collection indicates the type of waste. The computer may be further configured to receive the information relating to the scanned identification tag associated with the used waste container. Further, the computer may be configured to associate the identification tag of the used waste container with the type of waste and trigger the sorting mechanism to dispose the used waste container.

In an embodiment, the request for collection further indicates a user identifier, and wherein the computer may be further configured to associate the identification tag of the used waste container with the user identifier.

In an embodiment, the apparatus further includes a plurality of sensors to measure at least one of: weight data, proximity data, or motion data, wherein the plurality of sensors is provided in association with at least one of: the receiver section, and the dispensing section.

In an embodiment, the garbage handling apparatus further includes an access control mechanism configured to provide access to at least one of: the receiver section based on the request for collection, or the dispensing section based on the request for dispensing.

In an embodiment, the computer further includes a visually independent user interface.

In an embodiment, the garbage handling apparatus further includes an air stream generating mechanism arranged in association with at least one of: the receiver section, or the dispensing section, wherein the air stream generating mechanism comprises one or more blowers to blow air when an access to at least one of: the receiver section, or the dispensing section is provided.

In an embodiment, the garbage handling apparatus further includes one or more storage containers to store the used waste container, wherein each of the one or more storage containers is associated with a waste type.

In an embodiment, the garbage handling apparatus further includes a robotic arm, wherein the computer is configured to control the robotic arm to transfer the used waste container into one of one or more storage containers based on the type of waste.

In an embodiment, the garbage handling apparatus further includes a transportation mechanism extending between the receiver section and one or more storage containers, wherein the computer is configured to control an operation of the transportation mechanism to transfer the used waste container into one of the one or more storage containers based on the type of waste.

In an embodiment, the garbage handling apparatus further includes a motorized rail winch having a vacuum grip, wherein the computer is configured to control an operation of the motorized rail winch to transfer the used waste container into one of the one or more storage containers based on the type of waste.

In an embodiment, the garbage handling apparatus is placed within an inner space of a level higher than a threshold level of a multilevel building, and wherein the garbage handling apparatus further comprises one or more garbage chutes extending between the receiver section and one or more storage containers for transportation of the used waste container to one of the one or more storage containers based on the type of waste.

In an embodiment, the garbage handling apparatus further incudes an underground transportation mechanism extending between the receiver section and one or more underground transportation pipes, wherein the computer is configured to cause the underground transportation mechanism to transfer the used waste container into one of the one or more underground transportation pipes.

In another aspect, a system for garbage handling is provided. The system includes a garbage handling apparatus comprising a container vault to store one or more containers for waste disposal, a dispensing section to dispense at least one container from the one or more containers, and a receiver section to receive a used waste container. The system further includes a memory that stores instructions, and a processor connected to the memory and the garbage handling apparatus. The processor is configured to execute the instructions to trigger a dispensing mechanism to move the at least one container from the container vault to the dispensing section based on a request for dispensing. The processor is further configured to trigger a sorting mechanism to dispose the used waste container based on a request for collection of the used waste container, wherein the request for collection indicates a type of waste and the sorting mechanism is performed based on the type of waste.

In yet another aspect, a method for garbage handling is provided. The method is implemented using a garbage handling apparatus comprising a container vault, a dispensing section, a receiver section, and a computer. The method includes receiving, by the computer, one of: a request for dispensing, or a request for collection of a used waste container. The method further includes performing at least one of: triggering a dispensing mechanism to move the at least one container from the container vault to the dispensing section based on a request for dispensing or triggering a sorting mechanism to dispose the used waste container based on a request for collection of the used waste container. The request for collection indicates a type of waste and the sorting mechanism is performed based on the type of waste.

In another aspect, a computer programmable product for garbage handling is provided. The computer programmable product includes a non-transitory computer-readable storage medium having stored thereon computer executable instructions, which when executed by one or more processors, cause the one or more processors to carry out operations for garbage handling. The operations comprise receiving at least one of: a request for collection of a used waste container, or a request for dispensing. The operations may further include performing at least one of: triggering a dispensing mechanism to move the at least one container from the container vault to the dispensing section based on a request for dispensing, or triggering a sorting mechanism to dispose the used waste container based on a request for collection of the used waste container, wherein the request for collection indicates a type of waste and the sorting mechanism is performed based on the type of waste.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a block diagram of a garbage handling apparatus, in accordance with an embodiment of the disclosure;

FIG. 2 illustrates a block diagram of a system for garbage handling, in accordance with an embodiment of the disclosure;

FIG. 3A and FIG. 3B illustrate exemplary schematic diagrams of the garbage handling apparatus, in accordance with an embodiment of the disclosure;

FIG. 4A, FIG. 4B, FIG. 4C, FIG. 4D and FIG. 4E illustrate exemplary schematic diagrams for collection of used waste container by the garbage handling apparatus, in accordance with various embodiments of the disclosure;

FIG. 5 illustrates a network environment in which the system for garbage handling apparatus is implemented, in accordance with an embodiment of the disclosure;

FIG. 6 is a flowchart that illustrates exemplary operations of the garbage handling apparatus, in accordance with an embodiment of the disclosure; and

FIG. 7A and FIG. 7B illustrate a flowchart of an exemplary method for garbage handling, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

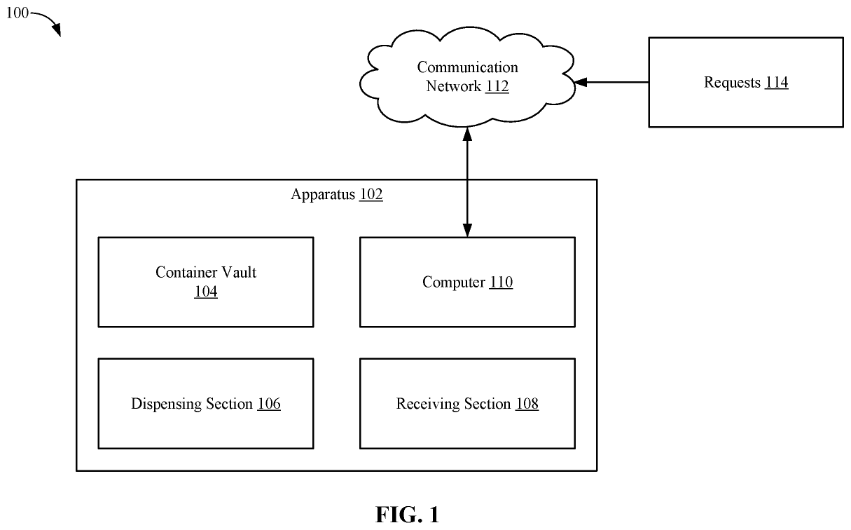

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 7, a brief description concerning the various components of the present disclosure will now be briefly discussed. Reference will be made to the figures showing various embodiments of the apparatus for garbage handling.

FIG. 1 illustrates a block diagram 100 of a garbage handling apparatus 102, in accordance with an embodiment of the disclosure. With reference to FIG. 1, there is shown the block diagram 100. The garbage handling apparatus 102 may include a container vault 104, a dispensing section 106, a receiving section 108, and a computer 110.

The garbage handling apparatus 102 (referred to as apparatus 102 hereinafter) may have the capability of managing waste, for example, but not limited to sorting waste and processing waste to encourage proper waste disposal.

Generally, designated dumpsters may be placed within residential complexes for specific types of waste such as metal, glass, paper, plastic, and food. Such dumpsters may be easily accessible to individuals, thereby making them susceptible to theft of pre-sorted metal. Further, the theft may lead to financial losses for waste processing facilities.

To overcome this issue, the apparatus 102 may provide a smart waste management system. Such apparatus 102 may further correspond to an intermediary device between the individuals and dumpsters, thereby providing protection of the disposed waste content by preventing direct access.

The container vault 104 may be configured to store one or more containers for waste disposal. The one or more containers may correspond to one or more empty storage boxes to hold waste material. Example, of the one or more containers may include but are not limited to bins, cans, bags, or any other receptacles. Such containers may be made of plastic, metal, cardboard, waterproof paper, or other suitable materials. In an embodiment, the one or more containers may be designed for waste disposal use. In an example, the one or more containers may be intended for one-time use and are made up of recyclable materials. In an embodiment, the one or more containers may be designed such that they do not hold their shape for example, garbage disposal bag. In such a case, the one or more containers may further include a self-adhesive flap for secure sealing, thereby making them odor-proof, and spill-proof. In another embodiment, the one or more containers may be designed to hold their shape. In such a case, the one or more containers may further include a tightly attachable lid with adhesive properties.

Further, the dispensing section 106 may be configured to dispense at least one container from the one or more containers. In such a scenario, the at least one container may correspond to an empty waste container. The receiver section 108 may be configured to receive a used waste container.

Further the computer 110 may be configured to perform one or more operations associated with the garbage handling apparatus 102. The computer 110 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the computer 110 may include one or more processing cores configured to perform independently. A multi-core processor may enable multiprocessing within a single physical package. For example, when the computer 110 may be embodied as an executor of software instructions, the instructions may specifically configure the computer 110 to perform the algorithms and/or operations described herein when the instructions are executed.

For example, the computer 110 may be configured to receive requests 114 for at least one of dispensing an empty container or collection of the used container. In particular, request 114 may include a request for collection of a used waste container. Alternatively, or additionally, the requests 114 may include a request for dispensing of an unused waste container from the container vault 104. Thereafter, the computer 110 may be configured to trigger a dispensing mechanism to move the at least one container from the container vault 104 to the dispensing section 106 based on the request for dispensing. Further, the computer 110 may be configured to trigger a sorting mechanism to dispose of the used waste container based on the request for collection of the used waste container. The request for collection indicates a type of waste and the sorting mechanism is performed based on the type of waste.

The apparatus 102 may be communicatively coupled to a user device, or any other device, via a communication network 112. The communication network 112 may be wired, wireless, or any combination of wired and wireless communication networks, such as cellular, Wi-Fi, internet, local area networks, or the like. In some embodiments, the communication network 112 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

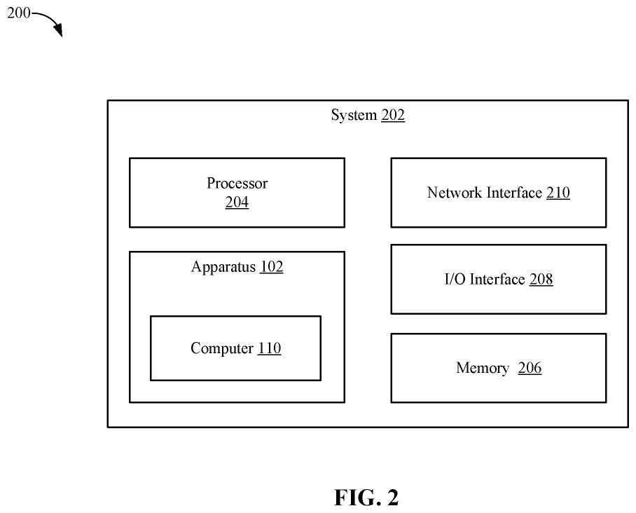

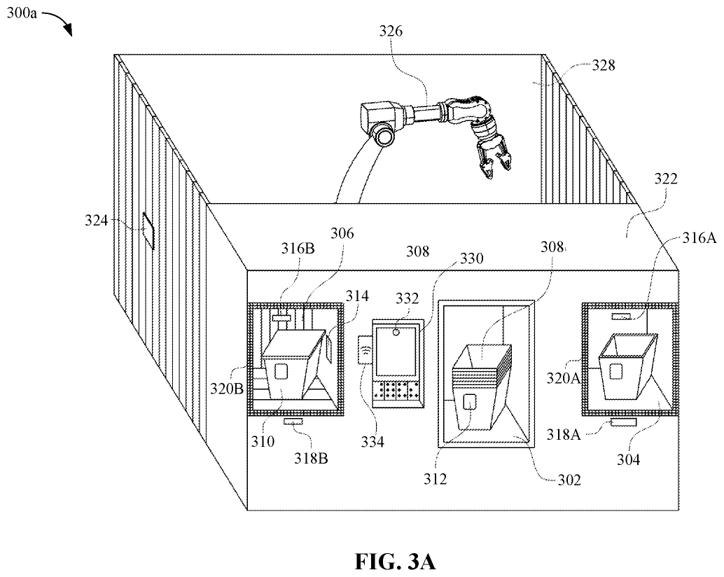

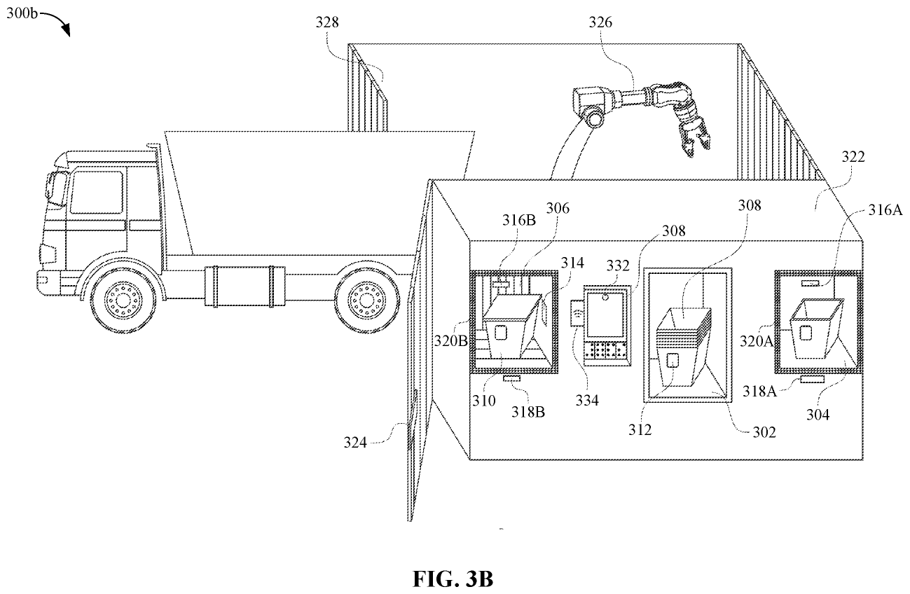

All the components in the apparatus 102 may be coupled directly or indirectly to the communication network 112. The components described may be further broken down into more than one component and/or combined together in any suitable arrangement. Further, one or more components may be rearranged, changed, added, and/or removed. Details of the operations of the apparatus 102 are described in conjunction with, for example, FIG. 2, FIGS. 3A-3B, FIGS. 4A-4E, FIG. 5, FIG. 6, and FIGS. 7A-7B.

FIG. 2 illustrates a block diagram of a system for garbage handling, in accordance with an embodiment of the disclosure. FIG. 2 is explained in conjunction with elements from FIG. 1. With reference to FIG. 2, there is shown the block diagram 200. The system 202 may include at least one processor (referred to as a processor 204, hereinafter), at least one non-transitory memory (referred to as a memory 206, hereinafter), an input/output (I/O) interface 208, a network interface 210, and the apparatus 102. The processor 204 may be connected to the apparatus 102, the memory 206, the I/O interface 208, and the network interface 210 through one or more wired or wireless connections. Although in FIG. 2, it is shown that the system 202 includes the processor 204, the memory 206, the I/O interface 208, and the network interface 210. However, the disclosure may not be so limiting and the system 202 may include fewer or more components to perform the same or other functions of the system 202.

The processor 204 of the system 202 may be configured to perform one or more operations associated with the garbage handling apparatus 102. The processor 204 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 204 may include one or more processing cores configured to perform independently. A multi-core processor may enable multiprocessing within a single physical package. Additionally, or alternatively, the processor 204 may include one or more processors configured in tandem via the bus to enable independent execution of instructions, pipelining, and/or multithreading. Additionally, or alternatively, the processor 204 may include one or more processors capable of processing large volumes of workloads and operations to provide support for big data analysis. In an example embodiment, the processor 204 may be in communication with the memory 206 via a bus for passing information among components of the system 202.

For example, when the processor 204 may be embodied as an executor of software instructions, the instructions may specifically configure the processor 204 to perform the algorithms and/or operations described herein when the instructions are executed. However, in some cases, the processor 204 may be a processor-specific device (for example, a mobile terminal or a fixed computing device) configured to employ an embodiment of the present disclosure by further configuration of the processor 204 by instructions for performing the algorithms and/or operations described herein. The processor 204 may include, among other things, a clock, an arithmetic logic unit (ALU), and logic gates configured to support the operation of the processor 204. The communication network may be accessed using the network interface 210 of the system 202. The network interface 210 may provide an interface for accessing various features and data stored in the system 202.

The memory 206 may be non-transitory and may include, for example, one or more volatile and/or non-volatile memories. In other words, for example, the memory 206 may be an electronic storage device (for example, a computer readable storage medium) comprising gates configured to store data (for example, bits) that may be retrievable by a machine (for example, a computing device like the processor 204). The memory 206 may be configured to store information, data, content, applications, instructions, or the like, for enabling the system 202 to carry out various functions in accordance with an example embodiment of the present disclosure. For example, the memory 206 may be configured to buffer input data for processing by the processor 204. As exemplified in FIG. 2, the memory 206 may be configured to store instructions for execution by the processor 204. As such, whether configured by hardware or software methods, or by a combination thereof, the processor 204 may represent an entity (for example, physically embodied in circuitry) capable of performing operations according to an embodiment of the present disclosure while configured accordingly. Thus, for example, when the processor 204 is embodied as an Application Specific Integrated Circuit (ASIC), Field Programmable Gate Array (FPGA), or the like, the processor 204 may be specifically configured hardware for conducting the operations described herein.

In some example embodiments, the I/O interface 208 may communicate with the system 202 and display the input and/or output of the system 202. As such, the I/O interface 208 may include a display and, in some embodiments, may also include a keyboard, a mouse, a touch screen, touch areas, soft keys, or other input/output mechanisms. In one embodiment, the system 202 may include a user interface circuitry configured to control at least some functions of one or more I/O interface elements such as a display and, in some embodiments, a plurality of speakers, a ringer, one or more microphones and/or the like. The processor 204 and/or I/O interface 208 circuitry including the processor 204 may be configured to control one or more functions of one or more I/O interface 208 elements through computer program instructions (for example, software and/or firmware) stored on a memory 206 accessible to the processor 204.

The network interface 210 may include the input interface and output interface for supporting communications to and from the system 202 or any other component with which the system 202 may communicate. The network interface 210 may be any means such as a device or circuitry embodied in either hardware or a combination of hardware and software that is configured to receive and/or transmit data to/from a communications device in communication with the system 202. In this regard, the network interface 210 may include, for example, an antenna (or multiple antennae) and supporting hardware and/or software for enabling communications with a wireless communication network. Additionally, or alternatively, the network interface 210 may include the circuitry for interacting with the antenna(s) to cause transmission of signals via the antenna(s) or to handle receipt of signals received via the antenna(s). In some environments, the network interface 210 may alternatively or additionally support wired communication. As such, for example, the network interface 210 may include a communication modem and/or other hardware and/or software for supporting communication via cable, digital subscriber line (DSL), universal serial bus (USB), or other mechanisms.

FIG. 3A illustrates an exemplary schematic diagram of the garbage handling apparatus, in accordance with an embodiment of the disclosure. FIG. 3B is explained in conjunction with elements from FIGS. 1, and 2. With reference to FIG. 3A, there is shown the diagram 300a of the system 202 for garbage handling including the apparatus 102.

As shown in the FIG. 3A, the system 202 may include a wall-like housing 322 positioned along a perimeter of an enclosed trash storage area 328. The housing 322 may enclose the apparatus 102 for garbage handling. In such a case, the apparatus 102 may be embedded into the wall of housing 322. In an embodiment, the housing 322 may correspond to a standalone facility such as a smart trash machine equipped with an automated garbage receiving window. Alternatively, the housing 322 may correspond to an extension of an existing building (such as a residential complex). Additionally, the housing can be embedded into walls and the garbage storage area can be located within the inner space of a building, allowing for versatile integration.

In an embodiment, the housing 322 may enclose inlet sections of the apparatus 102. The inlet sections may include at least one of a container vault 302, a dispensing section 304 and a receiver section 306. Such inlet sections may correspond to segments that may be locked and secured from individuals. For example, the inlet sections may be locked using but not limited to automatic and airtight doors, movable shatterproof glass, or any other suitable type of covering.

In an embodiment, the container vault 302 to store one or more containers 308 for waste disposal, the dispensing section 304 to dispense at least one container from the one or more containers 308, the receiver section 306 to receive a used waste container 310, and a computer 330. The computer 330 may be configured to trigger a dispensing mechanism to move the at least one container (such as the container 308) from the container vault 302 to the dispensing section 304 based on a request for dispensing. Further, the computer 330 may be configured to trigger a sorting mechanism to dispose the used waste container 310 based on a request for collection of the used waste container 310. The request for collection indicates a type of waste and the sorting mechanism is performed based on the type of waste.

It is to be noted that the terms “trash,” “garbage,” “rubbish” and “waste” may be used interchangeably throughout the patent application, without any deviation of scope in the application.

In an embodiment, the apparatus 102 may further include an access control mechanism configured to provide access to at least one of: the receiver section 306 based on the request for collection, or the dispensing section 304 based on the request for dispensing. In operation, a user may raise a request for dispensing of an empty waste container for garbage disposal. In an example, the user may raise the request 114 using a user interface. The user interface may correspond to a touch screen with a speaker and camera 332. In an example, the user interface may correspond to an interface of a software application on a user device (such as a mobile phone). Specifically, the user interface may correspond to an interface of a mobile application operating on the user's mobile device with processor.

In another example, the user interface may correspond to an interface connected with the computer 330. Specifically, the user interface may correspond to a touchscreen associated with the computer 110. Allowing users to interact with the smart trash machine via wireless connection. In such an example, the user interface may be automatically concealed inside the housing 322 during a storm or vandalism attempt. In an embodiment, the computer 330 may include a visually independent user interface. Specifically, the computer 330 may be configured to control mechanical keyboard and NFC reader sensor 334 adapted for blind or visually challenged individuals.

Typically, the user may create a user account on an online platform to access the apparatus 102. For providing the services to the user, the online platform may be required to authenticate the user to ensure that only authorized users can gain access to the services provided by the apparatus 102. In an embodiment, the apparatus 102 may include a user interface to receive the requests 114. To this end, the user may have to provide authentication information, such as a password, a pin, a code, etc. to enable their authentication.

Upon undergoing the identification process, the user may raise the request for dispensing the empty waste container. Thereafter, the request may be received by the computer 330, and the computer 330 may be configured to trigger the dispensing mechanism to move the at least one container (such as the container 308) from the container vault 302 to the dispensing section 304. Once the empty waste container reaches the dispensing section 304, the computer 330 may cause the access control mechanism to unlock the dispensing section 304 and the user may access the empty waste container. Thereafter, the empty waste container may be filled with waste and sealed to prevent spilling.

Thereafter, the user may request for collection of the used waste container 310. Upon receiving the request, the computer 330 may be configured to cause the access control mechanism to open the receiving section 306. The user may place their sealed used container in the receiving section 306. Thereafter, the computer 330 may be configured to trigger a sorting mechanism to dispose the used waste container 310. In an embodiment, an internal sub-device (not shown) that may be responsible for extracting and moving an individual empty waste container 308 from the container vault 302 to the dispensing section 304. The container vault 302 will only be accessible to maintenance staff for replenishment purposes. Once filled and properly sealed, the used waste container 310 should be placed into the used mobile container receiver section 306.

In an embodiment, the apparatus 102 may further include a plurality of sensors to measure weight data, proximity data, or motion data. The plurality of sensors may be provided in association with the receiver section 306, and the dispensing section 304. For example, the weight sensors in the receiver section 306 may sense weight data to check if a used waste container is placed in the receiver section 306. Alternatively, a proximity sensor in the receiver section 306 may measure proximity data to check if a user disposing the used waste container has safely withdrawn their hand before closing the receiver sensation 306 or disposing the used waste container to a storage container. Moreover, the proximity sensor in the dispensing section 304 may measure proximity data to check if a user collecting an unused waste container has safely withdrawn their hand before closing the dispensing section 304.

Further, the computer 330 may be configured to receive sensor data from the plurality of sensors to safely control the actions of the smart trash machine, i.e., the apparatus 102. Examples of the plurality of sensors may include, but are not limited to, weight sensor, gas sensor, infrared (IR) sensor, laser sensor, proximity sensor, ultrasonic sensor, and the like. Referring to FIG. 3A, a set of sensors (depicted as sensors 316A and 318A) may be present in the dispensing section, and another set of sensors (depicted as sensors 316B and 318B) may be present in the receiving section 306. In an example, the sensors 318A and 318B may be weight sensors that may be configured to determine weight data. Such weight sensors may be employed to detect the presence of the one or more containers within the dispensing section 304 and/or the receiver section 306. Specifically, the weight sensors may be positioned in association with a base of the dispensing section 304 and/or the receiver section 306 to detect whether or not the empty waste container 308 or the used waste container 310 is placed within the dispensing section 304 or the receiver section 306. In an example, the sensors 316A and 316B may correspond to proximity sensors that may be configured to determine proximity data. Such sensors may be employed to detect the presence of foreign objects, such as a user's arms or scattered rubbish items within the dispensing section 304 and the receiver section 306.

In an embodiment, the apparatus 102 may further include an air stream generating mechanism arranged in association with the receiver section 306 or the dispensing section 304. The air stream generating mechanism includes one or more blowers to blow air when an access to the receiver section 306, or the dispensing section 304 may be provided. In an example, the receiver section 306 and the dispensing section 304 may include airstream generation sub-devices positioned along the periphery of their input or access area. Such sub-devices may include the one or more blowers covered by grills 320A, and 320B along the periphery of the dispensing section 304, and the receiver section 306, respectively. Such placement of the one or more blowers may utilized by the blind individual to do a proper hands positioning based on tactile sensations of air flow, during interaction with at least one of: the dispensing section 304, and the receiver section 306.

FIG. 3B illustrates an exemplary schematic diagram of the garbage handling apparatus, in accordance with an embodiment of the disclosure. FIG. 3B is explained in conjunction with elements from FIGS. 1, 2, and 3A. With reference to FIG. 3B, there is shown the diagram 300b.

In an embodiment, each of the one or more containers 308 and the used waste container 310 may be associated with an identification tag 312. In an example, the identification tag 312 may be attached to a bottom of the used waste container 310. The user will have to place it upside down into the receiver section 306 to verify that it is securely sealed. Such an identification tag 312 may be employed to ensure proper functioning and safety of the smart trash machine.

In an embodiment, the receiver section 306 may be equipped with an internal sub-device that will flip the used waste container 310 multiple times before its transportation to the ejection hole 402, thereby checking or ensuring that used waste container 310 is securely sealed. Further, the identification tag 312 may be attached to at least one side of the used waste container 310. Such flipping of the used waste container 310 may ensure optimal scanning of the identification tag 312 as well as checking that the used waste container is properly sealed.

Further, the apparatus 102 may include an identification tag reader 314 arranged within the receiving section 306 to scan the identification tag 312 of the used waste container 310 and send information relating to the scanned identification tag 312 to the computer 330. In an embodiment, the empty waste container 308 stored in a vault section (such as the container vault 104) may be associated with the identification tag 312. Alternatively, or additionally, used waste container 310 received in the receiver section 306 may also be associated with the identification tag 312. In an example, the identification tag 312 may be attached to at least one side of the empty waste container 308. Examples of the identification tag reader 314 may include but are not limited to a QR code, NFC tag, or RFID chip sticker. Further, the identification tag 312 may be employed to create a database that records all disposed used waste containers along with their initial owners. This database can be stored in the memory 206 of the system 102 or on a remote server. It allows for the comprehensive tracking and management of the one or more containers throughout the disposal process.

In an embodiment, the identification tag reader 314 may be employed to relocate the bag to the dumpster associated with its specific content type. To facilitate this process, the smart trash machine is equipped with a built-in computer 330 and a user-facing interface, typically a touchscreen with the buttons for blind, located on the housing 322. Prior to using the machine, users are required to perform identification using the touchscreen or an alternative method. They also need to select the type of waste they have in their sealed trash bag.

To ensure optimal performance, the apparatus 102 exclusively utilizes its standardized trash bags. Users may have the option to obtain these bags for home use from a second automated window of the machine, which functions as a dispenser for unused trash bags. Each bag may be equipped with its unique identification tag 312 in the form of a QR code, NFC, or RFID chip sticker. This enables the apparatus 102 to maintain a virtual registry of used trash bags, including information about their declared content type and initial owner. Furthermore, the receiver section 310 may be equipped with a Quick Response (QR) code, Near Field Communication (NFC), or Radio Frequency Identification (RFID) chip sensor. Each sensor will transmit its data to the computer 330, which is configured to safely control the actions of the apparatus 102.

In an embodiment, the computer 330 may be further configured to receive the request for collection of the used waste container 310. The request for collection indicates the type of waste. The request for collection further indicates a user identifier, and wherein the computer 110 is further configured to associate the identification tag 312 of the used waste container 310 with the user identifier. Further, the computer 330 may be configured to receive the information relating to the scanned identification tag 312 associated with the used waste container 310. Thereafter, the computer 330 may be configured to associate the identification tag 312 of the used waste container 310 with the type of waste and trigger the sorting mechanism to dispose the used waste container 310.

In an embodiment, the trash storage area 328 may be equipped with gates that are secured by an electromagnetic lock 324. The electromagnetic lock 324 may automatically open and provide direct access to it, in the event of a blackout. In an example, the trash storage area 328 may be fenced to provide protection during usual time for a variety of used waste containers 310. In an example, a process of garbage collection from the trash storage area 328 is shown in FIG. 3B. In such an example, the computer 330 may be configured to disable the magnetic lock 324, thereby allowing gates of the trash storage area 328 to open for a garbage truck. Furthermore, in some embodiments, the trash storage area 328 may be located within the inner space of a building. This allows for flexible placement and integration of the smart trash machine within existing structures.

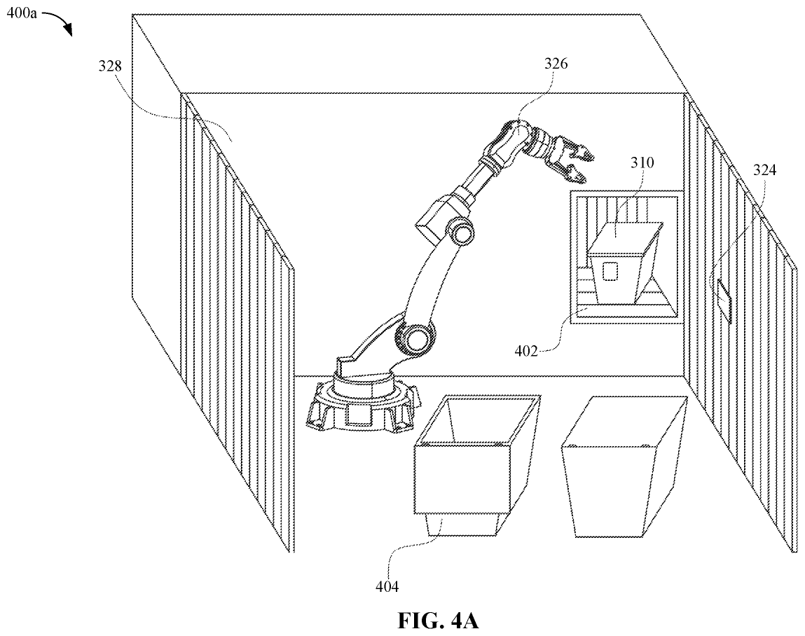

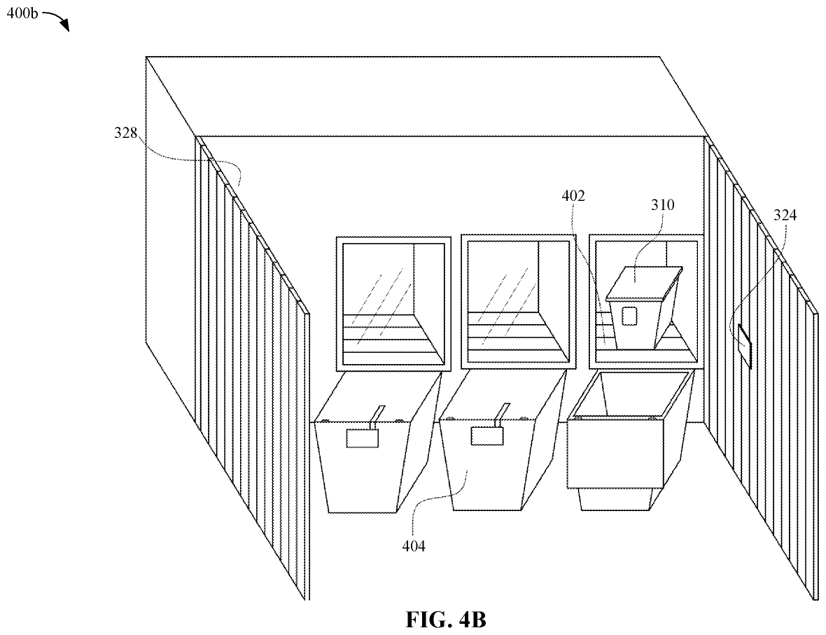

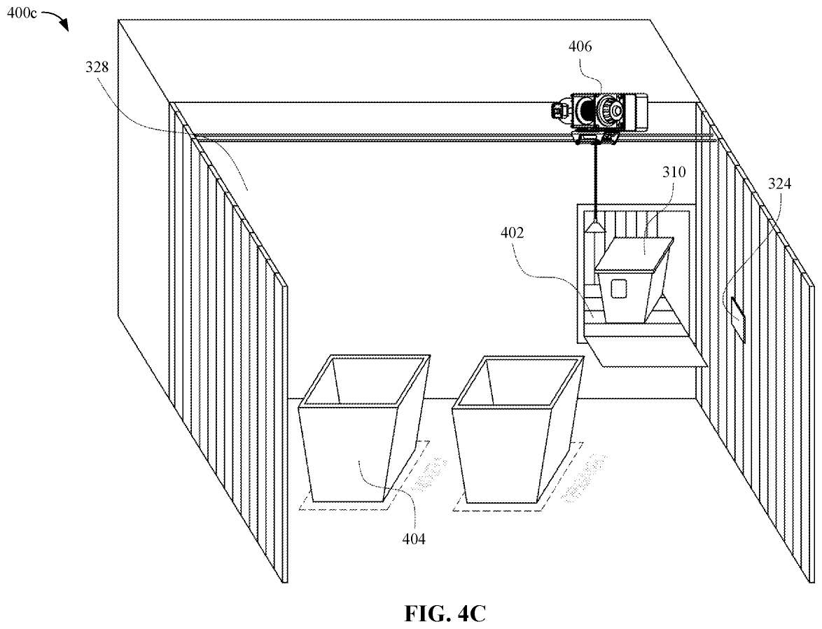

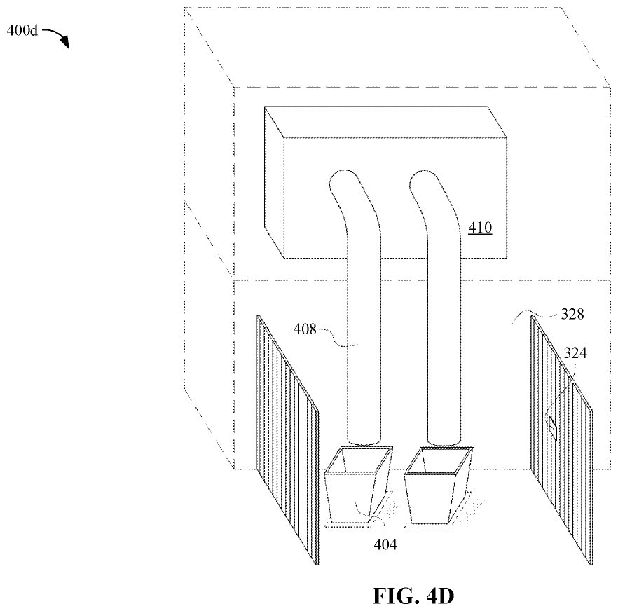

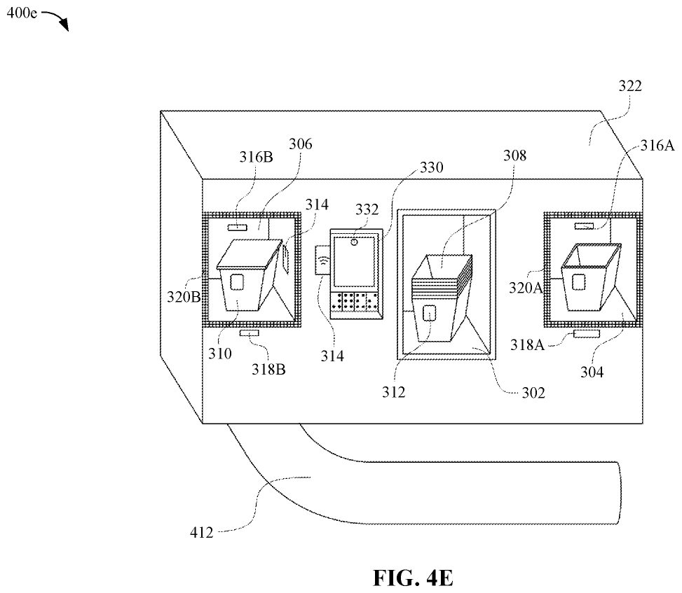

FIG. 4A illustrates an exemplary schematic diagram for collection of used waste containers in the garbage handling apparatus, in accordance with various embodiments of the disclosure. FIG. 4A is explained in conjunction with elements from FIGS. 1, 2, and 3. With reference to FIG. 4A, there is shown the diagram 400a.

In an embodiment, the apparatus 102 includes one or more storage containers 404 to store the used waste container 310, wherein each of the one or more storage containers is associated with a waste type. The storage container 404 may correspond to different types of containers such as, but not limited to, dumpsters, trailers, waste collectors, or any other storage capacity that is capable of being loaded with multiple used waste containers. Further the storage containers 404 may be used for storing and/or transporting the used waste containers 310 to their destination using a garbage truck or similar means of transportation. In an embodiment, the storage container 404 may have different visual appearances intended for a specific type of content, for its easier identification by humans or robots.

In an embodiment, the garbage handling apparatus 102 includes a robotic arm 326 (referred to as a manipulator 326). The computer 330 is configured to control the robotic arm to transfer the used waste container 310 into one of one or more storage containers 404 based on the type of waste. In this regard, the manipulator 326 sub-device may operate within the trash storage area 328. In an embodiment, the manipulator 326 may operate being connected to the smart trash machine's housing 326. In another embodiment, the manipulator 326 may operate independently. The manipulator 326 may be configured to relocate the used waste container 310 from an ejection hole 402 to the appropriate storage container 404 based on the specific declared waste type. For performing that task, it may be equipped with optical sensors or camera. It may also be configured to sequentially open/close the container's 404 lid.

It may be understood by one of ordinary skill in the art that fewer or a greater number of the apparatus, the inlet sections, the ejection holes, and the transportation mechanisms may be equivalently used in the system 202, without deviating from the scope of the present disclosure.

FIG. 4B illustrates an exemplary schematic diagram for collection of used waste containers in the garbage handling apparatus, in accordance with various embodiments of the disclosure. FIG. 4B is explained in conjunction with elements from FIGS. 1, 2, 3, and 4A. With reference to FIG. 4B, there is shown the diagram 400b.

In an embodiment, the apparatus 102 may include a transportation mechanism (such as a conveyor) extending between the receiver section 306 and the one or more storage containers 404. The computer 330 may be configured to control an operation of the transportation mechanism to transfer the used waste container 310 into the one of the one or more storage containers 404 based on the type of waste. In an example, the used waste container 310 will fall into an appropriate storage container from the one or more storage containers 404 by inertia as it reaches the moving conveyor's edge at one of the multiple ejection holes 402, as shown in FIG. 4B.

In another example, the storage container 404, placed in the trash storage area 328, may include a motorized cover along with an integrated controller and wireless module. In another example, one or more sensors may also be employed to control the storage of the used waste container 310. In an example, the computer 330 may establish a connection with it for simultaneous cover opening/closing initialization during used container 310 processing, as well as getting data from the sensors.

FIG. 4C illustrates an exemplary schematic diagram for collection of used waste containers in the garbage handling apparatus, in accordance with various embodiments of the disclosure. FIG. 4C is explained in conjunction with elements from FIGS. 1, 2, 3, 4A, and 4B. With reference to FIG. 4C, there is shown the diagram 400c.

In an embodiment, the manipulator 326 may be replaced with the motorized rail winch 406 having the vacuum grip, as shown in FIG. 4C. In such an embodiment, the garbage storage area 328 may include a motorized rail winch 406 having a vacuum grip positioned over the placement of the one or more storage containers 404. The computer 330 may be configured to control an operation of the motorized rail winch 406 to transfer the used waste container 310 into one of the one or more storage containers 404 based on the type of waste. In such an example, there may be markings on floor for the proper dumpsters 404 positioning in connection with the motorized rail winch 406. Each marking may correspond to a designated and specific type of waste. Such dumpster placement markings may ensure proper arrangement of the storage containers 404.

In an embodiment, the housing 322 features an ejection hole 402 that faces the inner space of the garbage storage area 328. It may also use a covering like receiver 306 and dispensing 304 sections. Internal sub-devices and mechanisms, partially masked, within the machine facilitate the movement of the used mobile container 310 from the receiver section 306 to the ejection hole 402. This can be achieved, without any limitations, by combining the receiver 306 section and ejection hole 402 into a common pass-through tunnel with a conveyor function, divided by an auto-retractable partition safety grille.

FIG. 4D illustrates an exemplary schematic diagram for collection of used waste containers in the garbage handling apparatus, in accordance with various embodiments of the disclosure. FIG. 4D is explained in conjunction with elements from FIGS. 1, 2, 3, 4A, 4B, and 4C. With reference to FIG. 4D, there is shown the diagram 400d.

In an embodiment, the garbage handling apparatus 102 may be placed within an inner space of a level higher than a threshold level of a multilevel building 410. The garbage handling apparatus 102 may further include one or more garbage chutes 408 extending between the receiver section 306 and one or more storage containers 404 for transportation of the used waste container 310 to one of the one or more storage containers 404 based on the type of waste. In an example, the apparatus 102 may be placed within the inner space of an upper floor, for example, higher than a threshold level of two floors of the multilevel building 410 as shown. One or more garbage chutes 408 may be connected to the machine's ejection hole(s) 402 and providing its connectivity with the garbage storage area 328.

FIG. 4E illustrates an exemplary schematic diagram for collection of used waste container in the garbage handling apparatus, in accordance with various embodiments of the disclosure. FIG. 4E is explained in conjunction with elements from FIGS. 1, 2, 3, 4A, 4B, 4C and 4D. With reference to FIG. 4E, there is shown the diagram 400e.

In an embodiment, the apparatus 102 may further include an underground transportation mechanism extending between the receiver section 306 and one or more underground transportation pipes 412. The computer 330 may be configured to cause the underground transportation mechanism to transfer the used waste container into one of the one or more underground transportation pipes 412. As shown in FIG. 4E the apparatus 102 may be connected to an underground trash transportation system. In this embodiment, the computer 330 may be configured to transfer a sealed used waste container 310 into the underground trash transportation pipe 412.

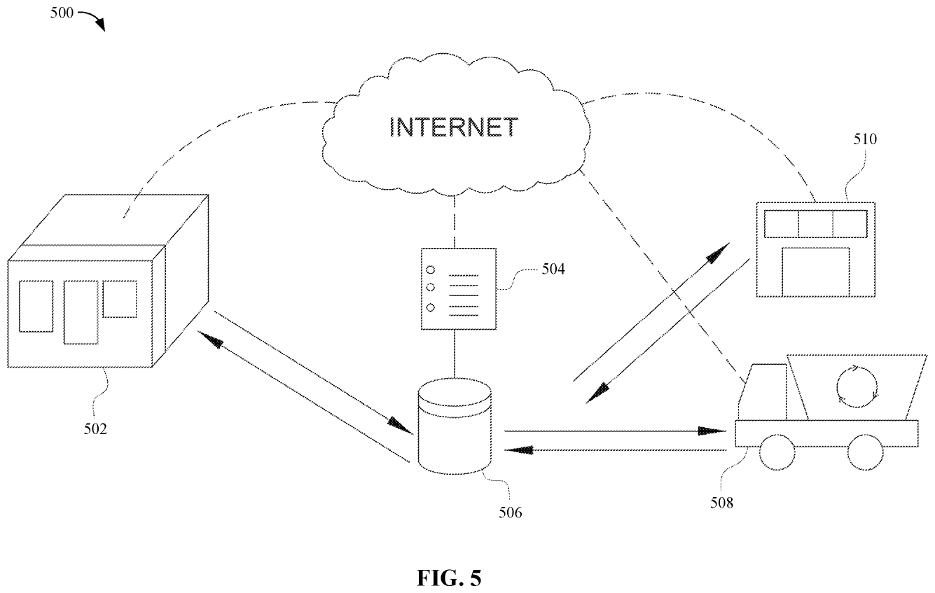

FIG. 5 illustrates a network environment in which the system for garbage handling apparatus is implemented, in accordance with an embodiment of the disclosure. FIG. 5 is explained in conjunction with elements from FIGS. 1, 2, 3A, 3B and 4A-4E. With reference to FIG. 5, there is shown the network environment 500. The network environment 500 may include one or more garbage handling apparatus 502 (for example, the apparatus 102), a server 504, a database 506 (for example the memory 206), a garbage collecting unit 508 (for example garbage trucks provider), a garbage receiving unit 510 (for example, waste recycling plant) and the communication network 112.

In an example, network environment 500 includes the garbage handling apparatus 502 connected to a server 504 over the communication network 112 (such as via the internet). The server 504 may correspond to a remote server that may be equipped with the processor 204 and maintains the database 506 in its memory 206. The database 506 may be configured to store both personal and billing information of the users, as well as information regarding the received used waste containers, and dispensed empty waste containers. Further, the garbage collecting unit 508 may utilize the database 506 to assess the apparatus 502 and individually bill their users. Furthermore, the garbage receiving unit 510 may be equipped with scanning devices capable of reading QR codes, NFC, or RFID chips. The garbage receiving unit 510 may utilize the database 506 to impose individual fines based on the information retrieved.

In an embodiment, the database 506 may be utilized to enforce individual fines in cases where a trash bag with incorrectly declared sorted content is detected at a garbage receiving unit 510. Additionally, it enables the implementation of a pay-per-use scheme for calculating individual garbage collection fees. The fees are determined based on the quantity of trash bags utilized by a specific user.

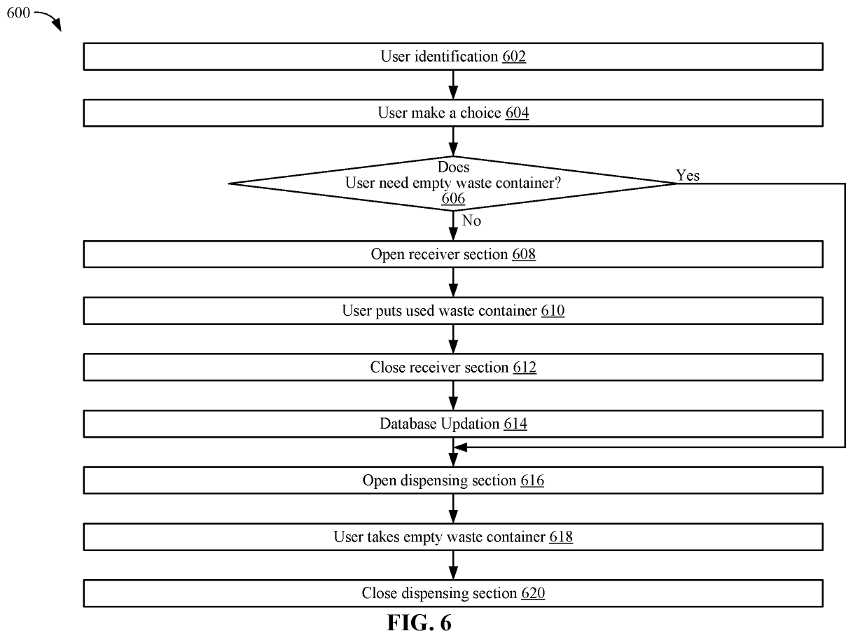

FIG. 6 is a flowchart that illustrates exemplary operations of the garbage handling apparatus, in accordance with an embodiment of the disclosure. FIG. 6 is explained in conjunction with elements from FIGS. 1, 2, 3A, 3B, 4A-4E, and 5. With reference to FIG. 6, there is shown a flowchart 600. The operations of the exemplary method may be executed by any computing system, for example, by the apparatus 102 of FIG. 1 or the system 102 of FIG. 2. The operations of the flowchart 600 may start at 602.

At 602, user identification may be done. In an embodiment, the computer 330 may be configured to perform user authentication by identifying the user by utilizing an NFC chip to the identification tag reader 314, using the touchscreen and/or mechanical keyboard of the machine's computer 330, or presenting a special QR code or their face to the camera 332, as described in FIG. 3A.

At 604, a choice may be made by the user. In an embodiment, the computer 330 may be configured to make at least one request for dispensing or collection of the used container. In an example, the user selects their desired action using the touchscreen or mechanical keyboard of the computer 330. The options include obtaining an empty waste container or disposing of a used waste container while specifying the type of waste.

At 606, whether the user needs an empty waste container may be determined. In an embodiment, the computer 330 may be configured to determine a type of request made by the user. Based on the type of request, the computer 330 may be configured to trigger at least one of the dispensing mechanism or the sorting mechanism. If the user raises the request for dispensing, the control may pass to 616. On the contrary, if the user raises the request for collection, the control may pass to 608.

At 608, a receiver section may be opened. In an embodiment, the computer 110 may trigger the sorting mechanism to dispose the used waste container 310 based on the request for collection of the used waste container 310. The request for collection may indicate a type of waste and the sorting mechanism is performed based on the type of waste.

At 610, the user may put the used waste container in the receiver section. In an example, the computer 330 may control the receiver section 306 to unlock and receive the used waste container 310. Further, the computer 330 may be configured to recognize the container's identification tag 312 using the identification tag reader 314. For example, the container's identification tag 312 may be recognized to associate user with the used waste container 308.

At 612, the receiver section may be closed. In an embodiment, Once the sensor checks have been passed, the receiver section 306 will be locked, and the sealed mobile container or used container 310 will be moved for further transportation, based on the specific embodiments as described in FIG. 4.

At 614, database may be updated. In an embodiment, the computer 330 may update the database 506 by adding a dataset that includes the action's date and time, the container's identification tag 312, the user's identifier (initial owner), the type of waste, and the current location (for tracking purposes, such as the trash machine's storage or a garbage receiving facility).

At 616, a dispensing section may be opened. In an embodiment, the computer 110 may trigger the dispensing mechanism to move at least one container 308 from the container vault 302 to the dispensing section 304 based on the request for dispensing.

At 618, the user may take the empty waste container from the dispensing section 304. In an example, the computer 330 may control the dispensing section 304 to unlock and dispense the empty waste container 308.

At 620, the dispensing section may be closed. Once the weight sensor 318A and the proximity sensor 316A determine that the dispensing section 304 is empty, it will be locked.

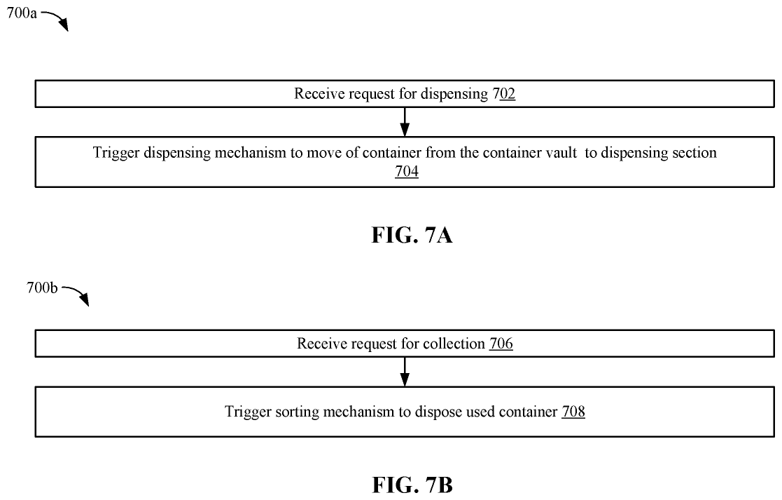

FIG. 7A is a flowchart that illustrates an exemplary method for garbage handling apparatus, in accordance with an embodiment of the disclosure. FIG. 7A is explained in conjunction with elements from FIGS. 1, 2, 3A, 3B, 4A-4E, 5, and 6. With reference to FIG. 7A, there is shown a flowchart 700a. The operations of the exemplary method may be executed by any computing system, for example, by the apparatus 102 of FIG. 1 or the system 102 of FIG. 2. The operations of the flowchart 700a may start at 702.

At 702, a request for dispensing may be received. In an embodiment, the computer 110 may receive the request for dispensing.

At 704, a dispensing mechanism may be triggered. In an embodiment, the computer 110 may trigger the dispensing mechanism to move at least one container 308 from the container vault 302 to the dispensing section 304 based on the request for dispensing.

FIG. 7B is a flowchart that illustrates an exemplary method for garbage handling apparatus, in accordance with an embodiment of the disclosure. FIG. 7B is explained in conjunction with elements from FIGS. 1, 2, 3A, 3B, 4A-4B, 5, 6, and 7A. With reference to FIG. 7B, there is shown a flowchart 700b. The operations of the exemplary method may be executed by any computing system, for example, by the apparatus 102 of FIG. 1 or the system 102 of FIG. 2. The operations of the flowchart 700b may start at 706.

At 706, a request for collection may be received. In an embodiment, the computer 110 may receive the request for collection of the used container 310.

At 708, a sorting mechanism may be triggered. In an embodiment, the computer 110 may trigger the sorting mechanism to dispose the used waste container 310 based on the request for collection of the used waste container 310. The request for collection may indicate a type of waste and the sorting mechanism is performed based on the type of waste.

Alternatively, the apparatus 102 may include means for performing each of the operations described above. In this regard, according to an example embodiment, examples of means for performing operations may comprise, for example, the processor and/or a device or circuit for executing instructions or executing an algorithm for processing information as described above.

Various embodiments of the disclosure may provide a non-transitory computer-readable medium having stored thereon computer executable instructions, which when executed by one or more processors (such as the processor 204), cause the one or more processors to carry out operations to operate a system (e.g., the system 202) for garbage handling. The instructions may cause the machine and/or computer to perform operations including receiving at least one of: a request for collection of a used waste container, or a request for dispensing. The operations may further include performing at least one of triggering a dispensing mechanism to move at least one container from the container vault to the dispensing section based on the request for dispensing or triggering a sorting mechanism to dispose the used waste container based on the request for collection of the used waste container, wherein the request for collection indicates a type of waste and the sorting mechanism is performed based on the type of waste.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed is:

1. A garbage handling apparatus, comprising:
a container vault to store one or more containers for waste disposal;
a dispensing section to dispense at least one container from the one or more containers;
a receiver section to receive a used waste container; and
a computer configured to:
trigger a dispensing mechanism to move the at least one container from the container vault to the dispensing section based on a request for dispensing, and
trigger a sorting mechanism to dispose the used waste container based on a request for collection of the used waste container, wherein the request for collection indicates a type of waste and the sorting mechanism is performed based on the type of waste.

2. The garbage handling apparatus of claim 1, wherein each of the one or more containers and the used waste container is associated with an identification tag.

3. The garbage handling apparatus of claim 1, further comprising an identification tag reader arranged within the receiving section to:
scan an identification tag of the used waste container; and
send information relating to the scanned identification tag to the computer.

4. The garbage handling apparatus of claim 3, wherein the computer is further configured to:
receive the request for collection of the used waste container, wherein the request for collection indicates the type of waste;
receive the information relating to the scanned identification tag associated with the used waste container;
associate the identification tag of the used waste container with the type of waste; and
trigger the sorting mechanism to dispose the used waste container.

5. The garbage handling apparatus of claim 1, wherein the request for collection further indicates a user identifier, and wherein the computer is further configured to associate the identification tag of the used waste container with the user identifier.

6. The garbage handling apparatus of claim 1, further comprising a plurality of sensors to measure at least one of: weight data, proximity data, or motion data, wherein the plurality of sensors are provided in association with at least one of: the receiver section, and the dispensing section.

7. The garbage handling apparatus of claim 1, further comprising an access control mechanism configured to provide access to at least one of: the receiver section based on the request for collection, or the dispensing section based on the request for dispensing.

8. The garbage handling apparatus of claim 1, further comprising an air stream generating mechanism arranged in association with at least one of: the receiver section, or the dispensing section, wherein the air stream generating mechanism comprises one or more blowers to blow air when an access to at least one of: the receiver section, or the dispensing section is provided.

9. The garbage handling apparatus of claim 1, further comprising one or more storage containers to store the used waste container, wherein each of the one or more storage containers is associated with a waste type.

10. The garbage handling apparatus of claim 1, further comprising a robotic arm, wherein the computer is configured to:
control the robotic arm to transfer the used waste container into one of one or more storage containers based on the type of waste.

11. The garbage handling apparatus of claim 1, further comprising a transportation mechanism extending between the receiver section and one or more storage containers, wherein the computer is configured to:
control an operation of the transportation mechanism to transfer the used waste container into one of the one or more storage containers based on the type of waste.

12. The garbage handling apparatus of claim 1, wherein the garbage handling apparatus is placed within an inner space of a level higher than a threshold level of a multilevel building, and wherein the garbage handling apparatus further comprises one or more garbage chutes extending between the receiver section and one or more storage containers for transportation of the used waste container to one of the one or more storage containers based on the type of waste.

13. The garbage handling apparatus of claim 1, further comprising an underground transportation mechanism extending between the receiver section and one or more underground transportation pipes, wherein the computer is configured to:
cause the underground transportation mechanism to transfer the used waste container into one of the one or more underground transportation pipes.

14. A system, comprising:
a garbage handling apparatus comprising a container vault to store one or more containers for waste disposal, a dispensing section to dispense at least one container from the one or more containers, and a receiver section to receive a used waste container;
a memory that stores instructions; and
a processor connected to the memory and the garbage handling apparatus, wherein the processor is configured to execute the instructions to:
trigger a dispensing mechanism to move the at least one container from the container vault to the dispensing section based on a request for dispensing, and
trigger a sorting mechanism to dispose the used waste container based on a request for collection of the used waste container, wherein the request for collection indicates a type of waste and the sorting mechanism is performed based on the type of waste.

15. The system of claim 14, wherein the garbage handling apparatus further comprises one or more storage container for storing the used waste container, and wherein the processor is further configured to:
cause to transfer the used waste container into one of the one or more storage containers based on the type of waste.

16. The system of claim 15, wherein the processor is further configured to:
store a database within the memory, the database comprising mapping data for at least one of: a user identifier of a user and the request for collection, the user identifier and a request for dispensing, or the user identifier and one or more identification tags;
assess fullness of the one or more storage containers based on the database; and
generate a request for the user based on the database, wherein the request is a payment request.

17. The system of claim 14, wherein the processor is further configured to:
receive at least one of: the user identifier, or information relating to an identification tag;
receive a selection associated with at least one of: the request for dispensing, or the request for disposal; and
perform at least one of:
trigger the dispensing mechanism and provide access to the dispensing section based on request for dispensing, or
trigger the sorting mechanism and provide access to the receiving section based on request for disposal.

18. A method for garbage handling, the method being implemented using a garbage handling apparatus comprising a container vault, a dispensing section, a receiver section and a computer, the method comprising:
receiving, by the computer, one of: a request for dispensing, or a request for collection of a used waste container; and
performing one of:
triggering a dispensing mechanism to move at least one container from the container vault to the dispensing section based on the request for dispensing, or
triggering a sorting mechanism to dispose the used waste container based on the request for collection of the used waste container, wherein the request for collection indicates a type of waste and the sorting mechanism is performed based on the type of waste.

19. The method of claim 18, wherein the used containers is associated with an identification tag, and wherein the method further comprises:
scanning the identification tag of the used waste container; and
sending information relating to the scanned identification tag to the computer.

20. The method of claim 19, further comprising
receiving the request for collection of the used waste container, wherein the request for collection indicates the type of waste;
receiving the information relating to the scanned identification tag associated with the used waste container;
associating the identification tag of the used waste container with the type of waste; and
triggering the sorting mechanism to dispose the used waste container.
